(19) United States
(12) Patent Application Publication
(10) Pub. No.: US 2015/0239052 A1
(43) Pub. Date: Aug. 27, 2015

(54) Circular Saw Blade

(71) Applicants: Robert Bosch Tool Corporation, Broadview, IL (US); Robert Bosch GmbH, Stuttgart (DE)

(72) Inventors: Elijah Trumble, Jamestown, NC (US); Marco Barbiero, Udine (IT); Manuel Toniutti, Udine (IT)

(21) Appl. No.: 14/629,219

(22) Filed: Feb. 23, 2015

Related U.S. Application Data
(60) Provisional application No. 61/945,504, filed on Feb. 27, 2014.

(51) Int. Cl. B23D 61/02

(52) U.S. Cl. CPC B23D 61/02

(57) ABSTRACT

A circular saw blade includes a disc-shaped body, and a plurality of cutting teeth fixedly connected to the disc-shaped body. The plurality of cutting teeth defines a tooth pitch of about 50 millimeters to 100 millimeters.

This application claims the benefit of priority of U.S. provisional application Ser. No. 61/945,504, filed Feb. 27, 2014, the disclosure which is herein incorporated by reference in its entirety.

### FIELD

This disclosure relates to the field of cutting tools and in particular to circular saw blades.

### BACKGROUND

Manufacturers have developed cutting tools for cutting thin materials such as laminate flooring products. Exemplary cutting tools include shear systems that use a single high carbon steel blade configured for a lever action cutting motion, portable saws such as table saws and miter saws, and handheld saws. Furthermore, there are also track saws that include a handheld saw and a track system configured to guide the handheld saw along a desired cut line.

It is a common understanding among manufactures and users alike that cutting tools having carbide teeth and a high tooth count (e.g. eighty plus cutting teeth, 80T) are good for cutting thin materials. The high number of small cutting teeth, typically results in a smooth cut of the material with minimal chipping. Since laminate flooring has a typical thickness of about seven to ten millimeters, it is seemingly suitable for being cut with a saw blade having a high tooth count of carbide cutting teeth. However, the materials used to form laminate flooring quickly dull known cutting tools.

Laminate flooring is typically formed from layers of high density fiberboard (“HDF”) and a layer of aluminum oxide on the uppermost surface. The layer of aluminum oxide is very hard and is provided to increase durability of the flooring product. The hardness of the aluminum oxide, however, very quickly dulls the cutting teeth of known cutting tools. For example, a circular saw blade having a high number of carbide cutting teeth is typically capable of making only approximately twenty cuts before the saw blade starts to dull and to burn the edge of the material being cut. To increase the life of the cutting tool some users invest in sliding action miter saws which cut material with a sliding motion, unlike a traditional miter saw that cuts material with a chopping motion. However, sliding miter saws are an expensive solution that only marginally increases the life of the cutting tool.

In view of the limitations of these prior blades, it would be desirable to develop a long-lasting cutting tool that makes smooth cuts in materials that are thin and hard, such as laminate and hardwood flooring products.

### SUMMARY

According to an exemplary embodiment of the disclosure, a circular saw blade includes a disc-shaped body, and a plurality of cutting teeth fixedly connected to the disc-shaped body. The plurality of cutting teeth defines a tooth pitch of about 50 millimeters to 100 millimeters.

According to another exemplary embodiment of the disclosure, a circular saw blade includes a disc-shaped body, a plurality of cutting sections located at a periphery of the disc-shaped body, and a plurality of cutting teeth. Each cutting section includes a gullet, a notch located at a first end of the gullet, a back point located at a second opposite end of the gullet and extending toward the notch, a first straight edge extending from the back point away from the gullet, and a second straight edge extending from the first straight edge away from the gullet. Each cutting tooth of the plurality of cutting teeth is fixedly connected to the disc-shaped body and at least partially located in a corresponding notch.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is an elevational view of a 7.25-inch circular saw blade, as described herein, that includes cutting teeth spaced apart at a desired tooth pitch that is especially suited for cutting materials that are thin and hard, such as laminate and hardwood flooring products;

FIG. 2 is cross sectional view taken along line II-II of FIG. 1;

FIG. 3 is an elevational view of a portion of the circular saw blade of FIG. 1 showing a first type of cutting tooth of the circular saw blade;

FIG. 4 is a side elevational view of a second type of cutting tooth of the circular saw blade of FIG. 1;

FIG. 5 is a top plan view of a portion of the circular saw blade of FIG. 1 showing the cutting tooth of FIG. 4;

FIG. 6 is an elevational view of a portion of the circular saw blade of FIG. 1 showing a front side of the cutting tooth of FIG. 4;

FIG. 7 is an elevational view of another embodiment of the circular saw blade, as described herein, shown as a 10-inch circular saw blade;

FIG. 8 is cross sectional view taken along line VIII-VIII of FIG. 7;

FIG. 9 is an elevational view of a portion of the cutting tool of FIG. 7 showing a first type of cutting tooth of the circular saw blade;

FIG. 10 is a side elevational view of a second type of cutting tooth of the circular saw blade of FIG. 7;

FIG. 11 is a top plan view of a portion of the circular saw blade of FIG. 7 showing the cutting tooth of FIG. 10;

FIG. 12 is an elevational view of a portion of the circular saw blade of FIG. 7 showing a front side of the cutting tooth of FIG. 10; and

FIG. 13 is an elevational view of yet another embodiment of the circular saw blade, as described herein, shown as a 12-inch circular saw blade.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

As shown in FIG. 1, a cutting tool is shown as a circular saw blade 100 configured for use with a circular saw, a table saw, a miter saw, or any other power saw that uses circular saw blades. The saw blade 100 is a 7.25-inch saw blade; however, the saw blade 100 may be configured in any desired size including 5.5-inch, 10-inch, 12-inch, and 14-inch models.

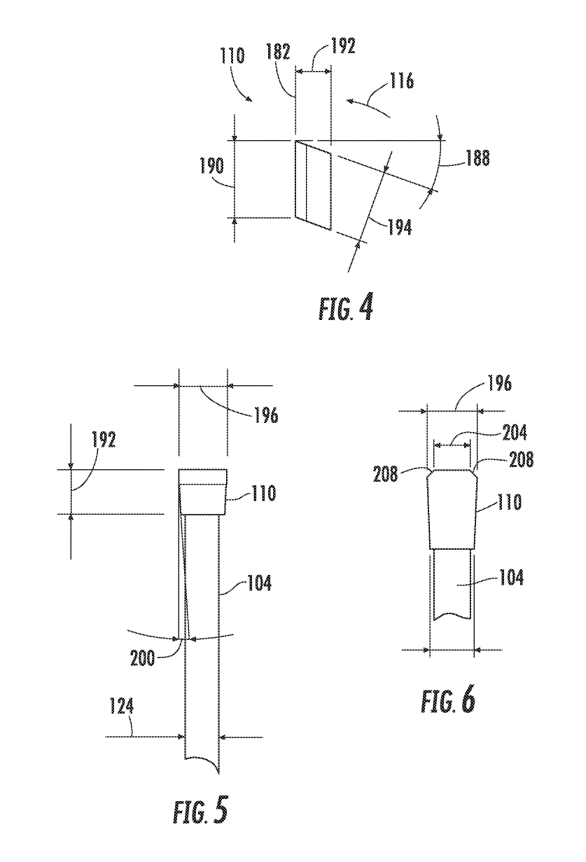

The saw blade 100 includes a disc-shaped body 104, a plurality of cutting teeth 108, 110 and, in some embodiments, a knock out structure 112. The body 104 is configured for rotation in a cutting direction 116 (counterclockwise in FIG. 1) about an axis of rotation 120 that extends through the body. In the embodiment of FIG. 1, the body 104 has a thickness 124 (FIG. 5) of about 1.3 millimeters. The body 104, in one embodiment, is formed from steel. In other embodiments, the body 104 may be formed from any desired material(s) that is hard and generally inflexible.

The body 104 defines a plurality of cutting sections 126 and a plurality of anti-vibration slots 148. The cutting sections 126 are evenly spaced around a periphery of the body 104, and each cutting section 126 includes a gullet 136, a back point 140, a notch 144, a first straight edge 146, and a second straight edge 150.

The gullet 136 is a substantially “U”-shaped void formed in the periphery of the body 104. The gullet 136 is configured to carry away debris generated by the cutting teeth 108, 110 during a cutting operation of the saw blade 100, thereby preventing the saw blade 100 from overheating. The gullet 136 defines a gullet length 137 that extends from a first end 154 of the gullet to an opposite second end 158 of the gullet. In the illustrated embodiment, the body 104 defines eight gullets 136. In other embodiments, the body 104 defines from one to thirty of the gullets 136 depending on the size of the saw blade 100.

The notch 144 is located at the first end 154 of the gullet 136 and is configured to receive a cutting tooth, such as one of the cutting teeth 108, 110. As shown in FIG. 3, the notch 144 is defined by a first edge 160 and a second edge 164 that are spaced apart from each other by a radiused edge 168. The notch 144 is located on the end 154 of the gullet 136 that is opposite from the back point 140. In one embodiment of the saw blade 100, the number of notches 144 is the same as the number of gullets 136 and the number of back points 140.

The back point 140 is located at the second opposite end 158 of the gullet 136 and is configured to extend toward the notch 144. The back point 140 is located a first radial distance 152 from the axis of rotation 120 and is configured to prevent binding of the saw blade 100 within a kerf of the workpiece during a cutting operation of the saw blade 100. A “C”-shaped portion 156 of the gullet 136 is positioned between the back point 140 and the axis of rotation 120. In the illustrated embodiment, the body 104 includes eight of the back points 140, but in other embodiments the body may include zero to twenty back points.

The first straight edge 146 extends from the back point 140 away from the gullet 136, and the second straight edge 150 extends from the first straight edge 146 away from the gullet 136. The second straight edge 150 extends from the notch 144 of an adjacent cutting section 126. In the exemplary embodiment of FIG. 1, the first straight edge 146 and the second straight edge 150 define an angle θ of about 175°. In other embodiments, the angle θ is from about 165° to 180°.

With reference to FIG. 1, the anti-vibration slots 148 are serpentine shaped slots that extend completely through the body 104 and are terminated with circular openings 172 through the body. The slots 148, in one embodiment, are evenly spaced around the axis of rotation 120. In the illustrated embodiment, the saw blade 100 includes four of the anti-vibration slots 148; however, in other embodiments, the saw blade may include zero to ten of the anti-vibration slots.

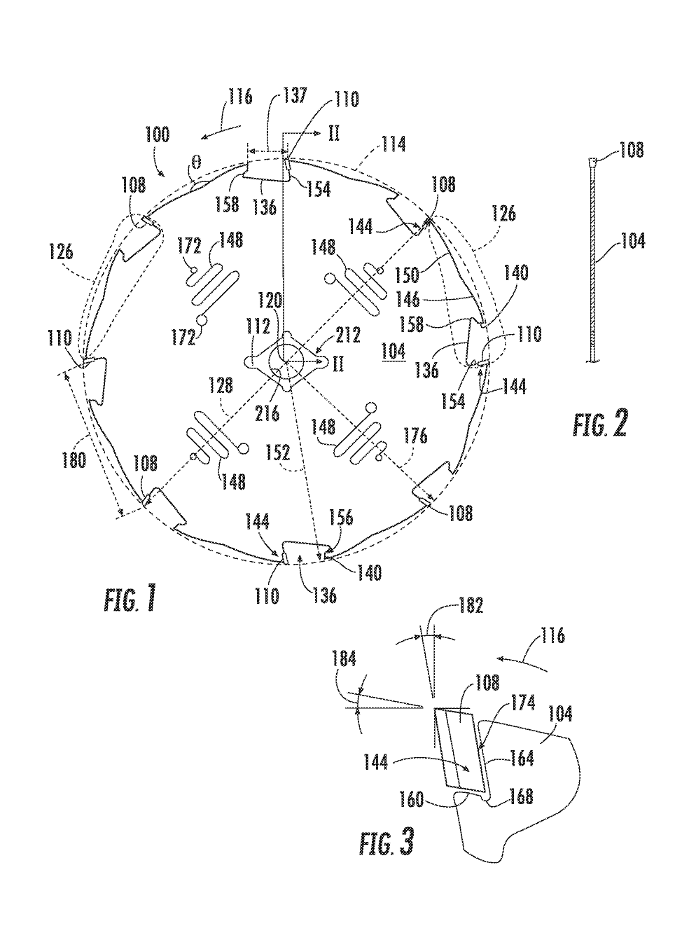

As shown in FIGS. 1 and 2, the cutting teeth 108, 110 are fixedly connected to the body 104 and are located at least partially in the notches 144. In one embodiment, the cutting teeth 108, 110 are welded to the body 104 and a welding material (not shown) fills the gap 174 between the cutting teeth and the body. In other embodiments, the cutting 108, 110 are connected to the body 104 using any desired connecting process. Each cutting tooth 108, 110 is located a second radial distance 176 (i.e. a radius of the circular periphery 114) from the axis of rotation 120. The second radial distance 176 is greater than the first radial distance 152 defined by the back points 140, such that the cutting teeth 108, 110 extend further from the axis of rotation 120 than the back points. In one embodiment, the cutting teeth 108, 110 are formed from carbide and, therefore, are very hard and wear resistant. Additionally, in some embodiments, the cutting teeth 108, 110 are coated with polycrystalline diamond (PCD) to be even harder and even more wear resistant. In other embodiments, the cutting teeth are formed from Cermet materials or other desired material(s).

The cutting teeth 108, 110 are spaced apart from each other by a distance referred to herein as a cutting tooth pitch 180. The tooth pitch 180 of the saw blade 100 is about 50 millimeters to 100 millimeters depending on the size (i.e. diameter) of the body 104, among other factors. In the embodiment illustrated in FIG. 1, the saw blade 100 is a 7.25-inch saw blade, the tooth pitch is about 72.26 millimeters, and the saw blade 100 includes eight of the cutting teeth 108, 110. In another embodiment, the saw blade 100 is a 10-inch saw blade, the tooth pitch is about 66.50 millimeters, and the saw blade 100 includes twelve of the cutting teeth 108, 110. In a further embodiment, the saw blade 100 is a 12-inch saw blade, the tooth pitch is about 59.85 millimeters, and the saw blade 100 includes sixteen of the cutting teeth 108, 110. As described below, the tooth pitch 180 is particularly suited for cutting hard and thin workpieces, such as laminate flooring products and hardwood flooring products (solid and engineered), cleanly and without excessive dulling.

The plurality of cutting teeth 108, 110 defines a circular periphery 114 of the saw blade 100. The circular periphery 114 is centered about an axis of rotation 120 of the saw blade 100 and includes a radial tip of each cutting tooth 108, 110. The tooth pitch 180 of the saw blade 100 equals the total number of cutting teeth 108, 110 divided by a circumference of the circular periphery 114. Accordingly, the tooth pitch 180 may also be specified as the number of cutting teeth 108, 110 per unit length of the circumference of the circular periphery 114.

The saw blade 100 may include at least two types of cutting teeth 108, 110; accordingly, the saw blade may include a first plurality of cutting teeth 108 and a second plurality of cutting teeth 110. The first and second types of cutting teeth 108, 110 may be interspersed with each other around the body 104 of the saw blade 100 in any desired configuration, such as an alternating configuration. In another exemplary embodiment, the saw blade 100 includes only the cutting teeth 108 or only the cutting teeth 110.

The first type of cutting tooth 108 is shown in FIG. 3. The cutting tooth 108 defines a positive hook angle 182 of approximately 10°. In other embodiments, the hook angle 182 may be approximately 5° to 25°. The cutting tooth 108 further defines a top clearance angle 184 of approximately 10°. In other embodiments, the top clearance angle 184 may be approximately 5° to 15°.

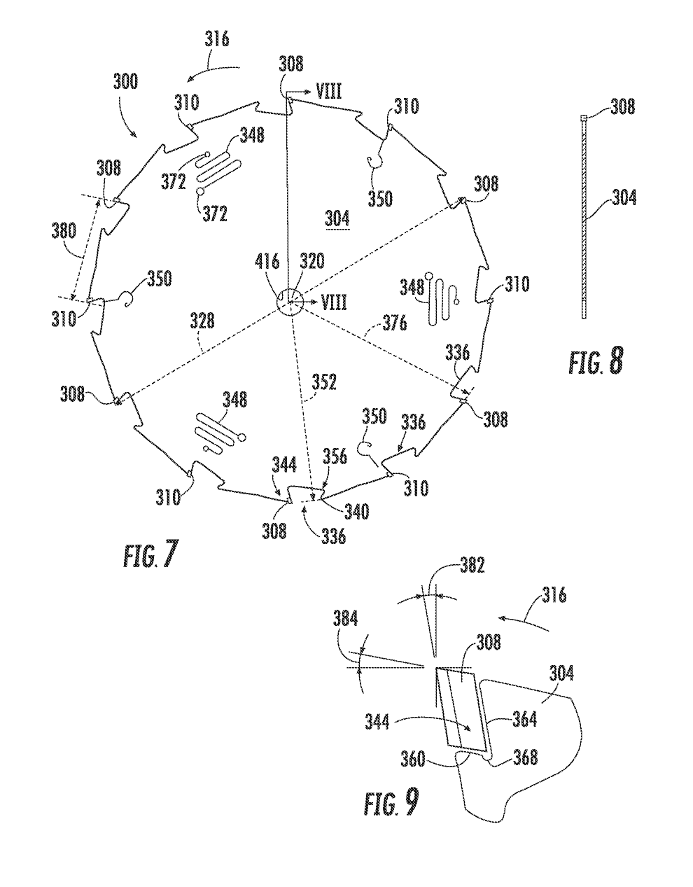

The second type of cutting tooth 110 is shown in FIGS. 4-6 and is referred to as a triple chip cutting tooth that defines a generally trapezoidal shape or profile (see FIG. 6). The cutting tooth 110 defines a height 190 of about 3.5 millimeters, a width 192 of about 1.6 millimeters, and a diagonal measurement 194 of about 3.29 millimeters. The cutting tooth 110 defines a depth measurement 196 of approximately 1.8 millimeters and a top clearance angle 188 of about 20°. In other embodiments, the top clearance angle 188 is about 5° to 30°. The cutting tooth 110 exhibits a hook angle 182 of −5° to 15°. In FIG. 4, the hook angle 182 of the cutting tooth 110 is shown as about 0°.

As shown in FIG. 6, the cutting tooth 110 defines chipped portions 208 that are angled at about a 45° angle on the top of both sides of the cutting tooth. In other embodiments, the chipped portions 208 are angled at 25° to 65°. The cutting tooth 110 defines a measurement 204 of approximately 1.4 millimeters and an angle 200 of about 4° relative to a plane of the body 104.

The above-described dimensions of the cutting teeth 108, 110 and the materials used to form and coat the cutting teeth 108, 110 are configured to make the saw blade 100 especially suited for making smooth cuts in materials such as laminate and hardwood flooring, as well as other thin materials, without chipping or burning the material.

With reference again to FIG. 1, the knock out structure 112 is positioned in a diamond-shaped arbor opening 212 formed in the body 104. The knock out structure 112 defines a circular arbor opening 216 configured to receive an arbor shaft (not shown) of a typical circular saw. The knock structure 112 is configured to be removed from the body 104 to enable use of the diamond-shaped arbor opening 212, which is configured to receive an arbor shaft of a typical worm-drive circular saw (not shown).

In operation, the saw blade 100 having the above-described cutting tooth pitch 180 is used to make smooth and clean cuts in hard and thin materials, such as laminate and hardwood flooring (referred to herein collectively as “flooring materials”), without causing chipping and without excessive dulling of the cutting teeth 108, 110. Specifically, the saw blade 100 has a very high durability/life advantage over conventional saw blade designs used for cutting flooring materials. In one embodiment, when cutting flooring materials, the saw blade 100 is more than approximately fifty times longer lasting than known saw blades used to cut flooring materials.

The tooth pitch 180 is one aspect that provides the saw blade 100 with the above-described longevity and durability. The tooth pitch 180 is much greater than known saw blades that are typically used for cutting flooring materials. For example, a known 7.25-inch saw blade configured to cut flooring materials may define a tooth pitch of about 7 millimeters and include about eighty cutting teeth. In the past, a high number of cutting teeth was the preferred configuration for achieving a smooth cut, and a saw blade with fewer cutting teeth (i.e. a higher tooth pitch) was thought to result in chipping and splintering of the flooring material. The inventors, however, determined that having a high tooth pitch 180 has certain advantages, especially when cutting flooring materials with a chop saw or miter saw. In particular, the high tooth pitch 180 results in a comparatively cooler cutting action because fewer cutting teeth 108, 110 strike and rub against the flooring material during the cutting operation. For example, for a given cutting operation the saw blade 100 strikes the flooring material about 15% as frequently as does the typical 7.25-inch that includes about 80 cutting teeth. As a result, significantly less friction is present between the rotating saw blade 100 and the flooring material and, therefore, less heat is transferred to the saw blade 100, which prevents burning of the flooring material and prolongs the life of the cutting teeth 108, 110 by protecting the PCD coating applied thereto. Extensive testing and research has shown that the tooth pitch 180 not only provides five to fifty times longer life over conventional saw blades, but the saw blade 100 also maintains a very good quality of cut without chipping over the entire usable life of the saw blade. Furthermore, the saw blade 100 is durable enough to stand up to hundreds of “chop” style cuts, thereby enabling the saw blade to be used in standard miter saws, table saws, or handheld saws. As a result, users no longer have to purchase specialty saw products, such as a sliding miter saws and track saws, to cut laminate flooring products.

The shape of the cutting sections 126 is another aspect that provides the saw blade 100 with the above-described longevity and durability. The cutting sections 126 are configured to efficiently remove debris from the kerf formed by the saw blade 100 so that little to no chipping and splintering of the flooring material occurs, even on account of the tooth pitch 180.

The material of the cutting teeth 108, 110, is another aspect that makes the saw blade 100 extremely durable and long-lived. The carbide cutting teeth 108, 110 having the PCD coating are extremely wear resistant, and when the cutting teeth 108, 110 are configured with the tooth pitch 180, the saw blade becomes an extremely durable blade for cutting laminate flooring and other similar products. The combination of above-described aspects results in a saw blade 100 that far exceeds the capabilities of known saw blades that are presently available in the market, since, as of this writing, there are no known blades on the market using PCD or carbide cutting teeth with the tooth pitch 180.

The saw blade 100 may be configured in any desired size including the following exemplary sizes. The saw blade 100 may be 5.5-inch saw blade having a tooth pitch 180 of about fifty millimeters to seventy-five millimeters. The saw blade 100 may be a 7.25-inch saw blade having a tooth pitch 180 of about fifty millimeters to seventy-five millimeters. The saw blade 100 may be a 10-inch saw blade having a tooth pitch 180 of about fifty millimeters to seventy-five millimeters. The saw blade 100 may be a 12-inch saw blade having a tooth pitch 180 of about fifty millimeters to seventy-five millimeters. The saw blade 100 may be a 14-inch saw blade having a tooth pitch of about fifty millimeters to seventy-five millimeters.

FIGS. 7-12 illustrate another embodiment of a cutting tool, as disclosed herein, which is shown as a 10-inch circular saw blade 300. Even though the saw blade 300 is similar to the saw blade 100, for completeness a description of the saw blade 300 is provided below. The saw blade 300 includes a body 304 and a plurality of cutting teeth 308, 310. The body 304 is a disc-like portion that, in one embodiment, is formed from steel. The body 304 is configured for rotation in a cutting direction 316 (counterclockwise in FIG. 7) about an axis of rotation 320 that extends through the body. In the embodiment of FIG. 7, the body 304 defines a thickness 324 (FIG. 11) of approximately 1.6 millimeters and a diameter 328 of approximately ten inches.

The body 304 defines a plurality of gullets 336, a plurality of back points 340, a plurality of notches 344, a plurality of anti-vibration slots 348, a plurality of expansion slots 350, and a circular arbor opening 416. The twelve gullets 336 are evenly spaced around the body 304.

The back points 340 extend from the body 304 and are pointed toward the cutting teeth 308, 310. In the illustrated embodiment, the body 304 includes twelve of the back points 340. Each back point 340 is located a first radial distance 352 from the axis of rotation 320. A “C”-shaped portion 356 of each gullet 336 is positioned between each back point 340 and the axis of rotation 320.

As shown in FIG. 9, each notch 344 of the plurality of notches is defined by a first edge 360 and a second edge 364 that are spaced apart from each other by a radiused edge 368. Each notch 344 is located on a side of a corresponding gullet 336 that is opposite from a corresponding back point 340.

With reference to FIG. 7, the anti-vibration slots 348 are serpentine-shaped slots that extend completely through the body 304 and are terminated with circular openings 372 through the body. The slots 348 are evenly spaced around the axis of rotation 320. In the illustrated embodiment, the saw blade 300 includes three of the anti-vibration slots 348; however, in other embodiments the saw blade 300 includes zero to six of the anti-vibration slots.

The expansion slots 350 are hook-shaped slots that are configured to reduce noise and vibration in response to rotation of the saw blade 300. Each expansion slot 350 extends from a corresponding gullet 336. The saw blade 300 includes three of the expansion slots 350; however, in other embodiments the saw blade includes zero to seven of the expansion slots.

As shown in FIG. 7, the cutting teeth 308, 310 are fixedly connected to the body 304 and are located at least partially in the notches 344. Each cutting tooth 308, 310 is located a second radial distance 376 from the axis of rotation 320. The second radial distance 376 is greater than the first radial distance 352 defined by the back points 340, such that the cutting teeth 308, 310 extend further from the axis of rotation 320 than do the back points. In one embodiment, the cutting teeth 308, 310 are formed form carbide and, therefore, are very hard and wear resistant. Additionally, in some embodiments, the cutting teeth 308, 310 are coated with polycrystalline diamond (PCD) to be even harder and even more wear resistant. In other embodiments, the cutting teeth 308, 310 are formed from Cermet materials or another other desired material or materials.

The cutting teeth 308, 310 are spaced apart from each other by a distance referred to herein as a cutting tooth pitch 380. The tooth pitch 380 of the saw blade 300 of FIG. 7 is about 66.50 millimeters. The tooth pitch 380 is particularly suited for cutting hard and thin workpieces, such as laminate and hardwood flooring, cleanly and without excessively dulling of the cutting teeth 308, 310.

The exemplary embodiment of the saw blade 300 includes at least two types of cutting teeth 308, 310. The first and second types of cutting teeth 308, 310 may be interspersed with each other around the body 304 of the saw blade 300 in any desired configuration.

A cutting tooth 308 of the first type is shown in FIG. 9. The cutting tooth 308 defines a positive hook angle 382 of about 10°. In other embodiments, the hook angle 382 may be about 5° to 25°. The cutting tooth 308 further defines a top clearance angle 384 of about 10°. In other embodiments, the top clearance angle 384 may be about 5° to 15°.

As shown in FIGS. 10-12, a cutting tooth 310 of the second type is shown. The cutting tooth 310 may be referred to as a triple chip cutting tooth. With reference to FIG. 10, the cutting tooth 310 defines a top clearance angle 388 of about 20°. In other embodiments, the top clearance angle 388 may be about 5° to 30°. The cutting tooth 310 further defines a height 390 of about 3.5 millimeters, a width 392 of about 1.6 millimeters, and a measurement 394 of about 3.29 millimeters.

As shown in FIG. 11, the cutting tooth 310 defines a measurement 396 of about 2.2 millimeters. The triple chip cutting tooth 310 has a generally trapezoidal shape with an angle 400 of about 4°.

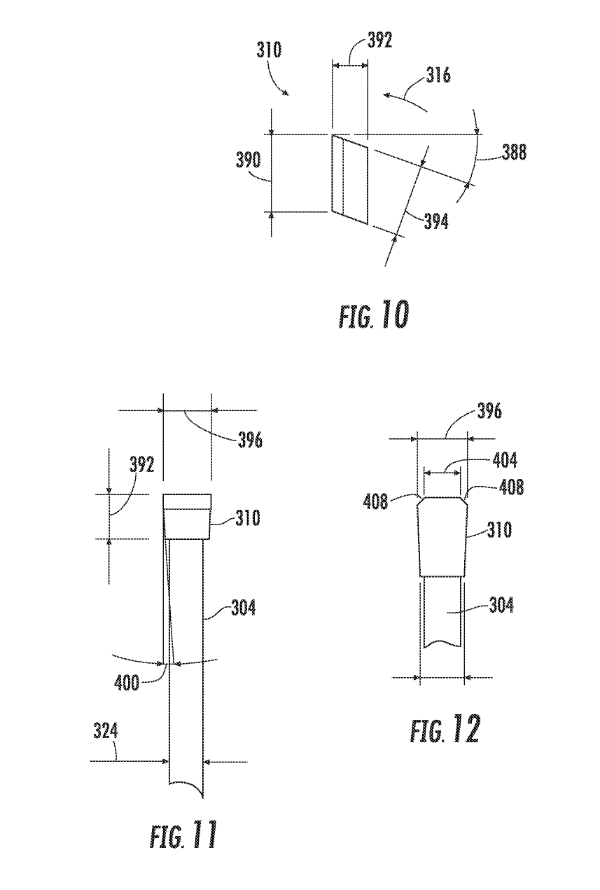

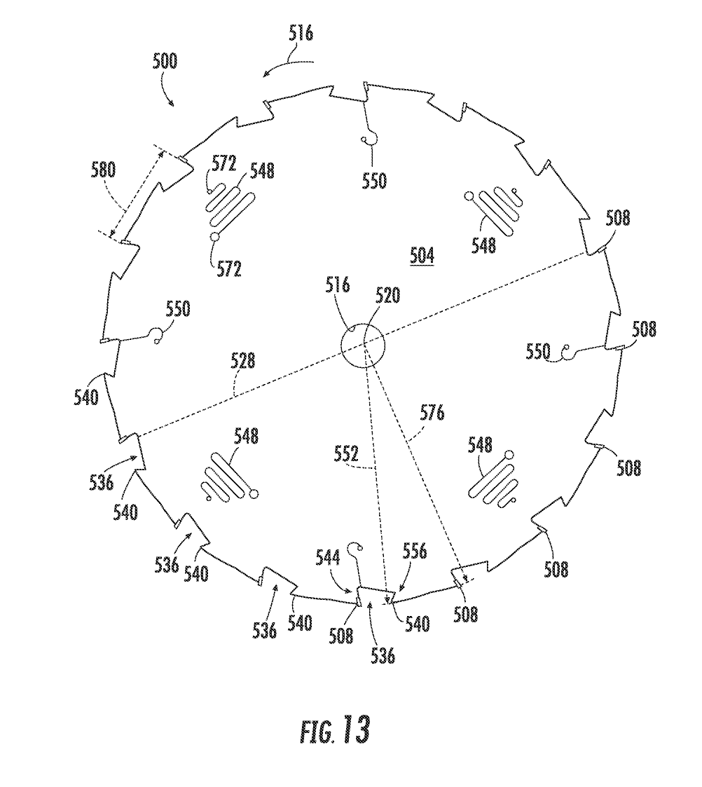

In FIG. 12, the cutting tooth defines a measurement 404 of about 1.4 millimeters. The cutting tooth 310 defines chipped portions 408 that are angled at about a 45° angle, in the illustrated embodiment. In other embodiments the chipped portions 408 are angled at 25° to 65°.

FIG. 13 illustrates another embodiment of a cutting tool, as disclosed herein, which is shown as a 12-inch circular saw blade 500. Even though the saw blade 500 is similar to the saw blades 100, 300, for completeness a description of the saw blade 500 is provided below. The saw blade 500 includes a body 504 and a plurality of cutting teeth 508. The body 504 is a disc-like portion that, in one embodiment, is formed from steel. The body 504 is configured for rotation in a cutting direction 516 (counterclockwise in FIG. 13) about an axis of rotation 520 that extends through the body.

The body 504 defines a plurality of gullets 536, a plurality of back points 540, a plurality of notches 544, a plurality of anti-vibration slots 548, and a plurality of expansion slots 550. The gullets 536 are evenly spaced around the body 504. In the illustrated embodiment, the body 504 defines sixteen of the gullets 536.

The back points 540 extend from the body 504 and are pointed toward the cutting teeth 508. In the illustrated embodiment, the body 504 includes sixteen of the back points 540. Each back point 540 is located a first radial distance 552 from the axis of rotation 520. A “C”-shaped portion 556 of each gullet 536 is positioned between each back point 540 and the axis of rotation 520.

The anti-vibration slots 548 are serpentine shaped slots that extend completely through the body 504 and are terminated with circular openings 572 through the body. The slots 548 are evenly spaced around the axis of rotation 520. In the illustrated embodiment, the saw blade 500 includes four of the anti-vibration slots 548.

The expansion slots 550 are hook-shaped slots that reduce noise and vibration in response to rotation of the saw blade 500. The saw blade 500 includes four of the expansion slots 550.

The cutting teeth 508 are fixedly connected to the body 504 and are located at least partially in the notches 544. Each cutting tooth 508 is located a second radial distance 576 from the axis of rotation 520. The second radial distance 576 is greater than the first radial distance 552 defined by the back points 540, such that the cutting teeth 508 extend further from the axis of rotation 520 than do the back points. In one embodiment, the cutting teeth 508 are formed form carbide and, therefore, are very hard and wear resistant. Additionally, in some embodiments, the cutting teeth 508 are coated with polycrystalline diamond (PCD) to be even harder and even more wear resistant. In other embodiments, the cutting teeth 508 are formed from Cermet materials or another other desired material or materials.

The cutting teeth 508 are spaced apart from each other by distance referred to herein as a cutting tooth pitch 580. The tooth pitch 580 of the saw blade 500 is about 59.85 millimeters. The tooth pitch 580 is particularly suited for cutting hard and thin workpieces, such as laminate and hardwood flooring, cleanly and without excessively dulling.

The saw blade 500 may include at least two types of cutting teeth 508 including straight teeth (see cutting teeth 108, FIG. 3) and/or triple chip cutting teeth (see cutting teeth 110, FIG. 6).

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A circular saw blade comprising:
a disc-shaped body; and
a plurality of cutting teeth fixedly connected to the disc-shaped body, the plurality of cutting teeth defining a tooth pitch of about 50 millimeters to 100 millimeters.

2. The circular saw blade of claim 1, wherein:
the plurality of cutting teeth defines a circular periphery,
a diameter of the circular periphery is about 7.25 inches, and
the tooth pitch is about 72 millimeters.

3. The circular saw blade of claim 2, wherein the plurality of cutting teeth includes only eight of the cutting teeth.

4. The circular saw blade of claim 1, wherein:
the plurality of cutting teeth defines a circular periphery,
a diameter of the circular periphery is about 10 inches, and
the tooth pitch is about 66 millimeters.

5. The circular saw blade of claim 1, wherein:
the plurality of cutting teeth defines a circular periphery,
a diameter of the circular periphery is about 12 inches, and
the tooth pitch is about 60 millimeters.

6. The circular saw blade of claim 1, wherein the cutting teeth of the plurality of cutting teeth are coated with polycrystalline diamond (PCD).

7. The circular saw blade of claim 1, wherein the cutting teeth of the plurality of cutting teeth are formed from carbide or cermet.

8. The circular saw blade of claim 1, wherein at least half the cutting teeth of the plurality of cutting teeth define a trapezoidal shape.

9. The circular saw blade of claim 8, wherein each cutting tooth defining a trapezoidal shape defines a first and a second chipped portion that are each angled about 45° from a top edge of the cutting tooth.

10. The circular saw blade of claim 1, wherein each cutting tooth of the plurality of cutting teeth defines a hook angle from about +15° to −5°.

11. A circular saw blade comprising:
a disc-shaped body;
a plurality of cutting sections located at a periphery of the disc-shaped body, each cutting section including a gullet, a notch located at a first end of the gullet, a back point located at a second opposite end of the gullet and extending toward the notch, a first straight edge extending from the back point away from the gullet, and a second straight edge extending from the first straight edge away from the gullet; and
a plurality of cutting teeth, each cutting tooth fixedly connected to the disc-shaped body and at least partially located in a corresponding notch.

12. The circular saw blade of claim 11, wherein the plurality of cutting teeth defines a tooth pitch of about 50 millimeters to 100 millimeters.

13. The circular saw blade of claim 12, wherein:
the plurality of cutting teeth defines a circular periphery,
a diameter of the circular periphery is about 7.25 inches, and
the tooth pitch is about 72 millimeters.

14. The circular saw blade of claim 12, wherein:
the plurality of cutting teeth defines a circular periphery,
a diameter of the circular periphery is about 10 inches, and
the tooth pitch is about 66 millimeters.

15. The circular saw blade of claim 14, wherein the plurality of cutting teeth includes only twelve of the cutting teeth.

16. The circular saw blade of claim 12, wherein:
the plurality of cutting teeth defines a circular periphery,
a diameter of the circular periphery is about 12 inches, and
the tooth pitch is about 60 millimeters.

17. The circular saw blade of claim 12, wherein:
the gullet defines a gullet length, and
a ratio of the tooth pitch to the gullet length is about 3.

18. The circular saw blade of claim 11, wherein an angle defined by the first straight edge and the second straight edge is from about 160° to 175°.

19. The circular saw blade of claim 11, wherein the gullet defines a C-shaped portion located between the back point and an axis of rotation of the disc-shaped body.

20. The circular saw blade of claim 11, wherein each cutting section includes only one cutting tooth of the plurality of cutting teeth.
